(19) United States
(12) Patent Application Publication
(10) Pub. No.: US 2023/0276340 A1
(43) Pub. Date: Aug. 31, 2023

(54) CAPABILITY REPORTING METHOD AND APPARATUS, AND CAPABILITY DETERMINATION METHOD AND APPARATUS

(71) Applicant: Beijing Xiaomi Mobile Software Co., Ltd., Beijing (CN)

(72) Inventors: Wei HONG, Beijing (CN); Ming ZHANG, Beijing (CN)

(21) Appl. No.: 18/005,479

(22) PCT Filed: Jul. 27, 2020
(86) PCT No.: PCT/CN2020/104922

§ 371 Date: Jan. 13, 2023

(51) Int. Cl. H04W 40/22; H04W 28/02

(52) U.S. Cl. CPC H04W 40/22; H04W 28/0215

(57) ABSTRACT

A method for capability reporting is performed by a terminal, and includes: sending capability information about a type of multi-modal communication or service supported by the terminal to a network device.

### CROSS-REFERENCE TO RELATED APPLICATION

This application is a U.S. national phase application of International Application No. PCT/CN2020/104922, filed on Jul. 27, 2020, the content of which is hereby incorporated by reference in its entirety.

### TECHNICAL FIELD

The disclosure relates to a field of communication technologies, and in particular, to a. method for capability reporting, a method for capability determining, an apparatus for capability reporting, an apparatus for capability determining, an electronic device, and a computer-readable storage medium.

### BACKGROUND

With the official commercial use of 5G technology, research on 6G technology has been put on the agenda. Smart interaction is a possible important application scenario in the 6G technology. The smart interaction refers to the intelligent interaction between intelligence agents (including people and things) Most of the existing interactions between the intelligence agents are passive and depend on the input of needs, such as voice or visual interaction between people and smart homes. Smart homes passively receive data input by people, and the input data is unimodal.

In the 6G era, more attention will be paid on the multi-modality. Inputs from multiple devices or multiple inputs from one device are sent to a centralized processing device, and the centralized processing device comprehensively processes these inputs, and finally obtains one or more types of inputs that meets user needs. The multiple outputs can be output through multiple devices or output through one device.

### SUMMARY

According to a first aspect of the disclosure, a method for capability reporting performed by a terminal is provided. The method includes:

sending capability information about a type of multi-modal communication or service supported by the terminal to a network device.

According to a second aspect of the disclosure, a method for capability determining performed by a network device is provided. The method includes:

receiving capability information sent by a terminal; and

determining a type of multi-modal communication or service supported by the terminal based on the capability information.

According to a third aspect of the disclosure, an electronic device is provided. The electronic device includes:

a processor; and

a memory for storing instructions executable by the processor;

in which the processor is configured to perform the above method for capability reporting, and/or the above method for capability determining.

According to a fourth aspect of the disclosure, a non-transitory computer-readable storage medium is provided. The storage medium has a computer program stored thereon. When the program is executed by a processor, the above method for capability reporting, and/or the above method for capability determining is performed.

### BRIEF DESCRIPTION OF THE DRAWINGS

The accompanying drawings used in the description of the embodiments will be described in the following. Obviously, the accompanying drawings in the following description are only used to illustrate example embodiments of the disclosure. For those of ordinary skill in the art, other embodiments can also be obtained.

FIG. 1 is a schematic flowchart illustrating a method for capability reporting according to embodiments of the disclosure.

FIG. 2 is a schematic flowchart illustrating another method for capability reporting according to embodiments of the disclosure.

FIG. 3 is a schematic flowchart illustrating yet another method for capability reporting according to some embodiments of the disclosure.

FIG. 4 is a schematic flowchart illustrating a method for capability determining according to some embodiments of the disclosure.

FIG. 5 is a schematic flowchart illustrating another method for capability determining according to embodiments of the disclosure.

FIG. 6 is a schematic flowchart illustrating yet another method for capability determining according to embodiments of the disclosure.

FIG. 7 is a schematic flowchart illustrating still another method for capability determining according to embodiments of the disclosure.

FIG. 8 is a schematic flowchart illustrating still another method for capability determining according to embodiments of the disclosure.

FIG. 9 is a schematic flowchart illustrating still another method for capability determining according to embodiments of the disclosure.

FIG. 10 is a block diagram illustrating an apparatus for capability reporting according to embodiments of the disclosure.

FIG. 11 is a block diagram illustrating another apparatus for capability reporting according to embodiments of the disclosure.

FIG. 12 is a block diagram illustrating an apparatus for capability determining according to embodiments of the disclosure.

FIG. 13 is a block diagram illustrating another method for capability determining according to some embodiments of the disclosure.

FIG. 14 is a block diagram illustrating yet another method for capability determining according to some embodiments of the disclosure.

FIG. 15 is a block diagram illustrating still another method for capability determining according to some embodiments of the disclosure.

FIG. 16 is a block diagram illustrating still another method for capability determining according to some embodiments of the disclosure.

FIG. 17 is a block diagram illustrating still another method for capability determining according to some embodiments of the disclosure.

FIG. 18 is a block diagram illustrating a device for capability determining according to embodiments of the disclosure.

FIG. 19 is a block diagram illustrating a device for capability reporting according to embodiments of the disclosure.

### DETAILED DESCRIPTION

The technical solutions in embodiments of the disclosure will be clearly and completely described below with reference to the accompanying drawings in embodiments of the disclosure. Obviously, the described embodiments are only a part of the embodiments of the disclosure, but not all of the embodiments. Based on the embodiments in the disclosure, all other embodiments obtained by those of ordinary skill in the art without creative efforts shall fall within the protection scope of the disclosure.

FIG. 1 is a schematic flowchart illustrating a method for capability reporting according to embodiments of the disclosure. The method shown in this embodiment may be performed by a terminal. The terminal is selected from a group including but not limited to electronic devices such as a mobile phone, a tablet computer, a wearable device, a sensor, and an Internet of Things device. The terminal can be user equipment (UE) to communicate with the network device such as a base station and a core network. The base station is selected from a group including but not limited to a 4G base station, a 5G base station, or a 6G base station. The core network is selected from a group including but not limited to a 4G core network, a 5G core network, or a 6G core network.

As illustrated in FIG. 1, the method for capability reporting may include the following.

In block S101, capability information about a type of multi-modal communication or service supported by the terminal is sent to the network device.

In an embodiment, the capability information may be an identifier corresponding to the type. For example, the identifier is represented by an index. Different types of the multi-modal communication or services correspond to different indexes, and the capability information may be the index corresponding to the type. In the case where the terminal supports multiple types of multi-modal communication or services, the capability information may include multiple indices, and the multiple indices may be represented in the form of List.

In an embodiment, with the improvement of the capabilities of the terminal, the terminal can support the multi-modal communication or service. For example, the terminal can support one type of multi-modal communication or service or more than one type of multi-modal communications or services. When initiating the multi-modal communication or service, the terminal may collect multi-modal information and communicate with other devices (such as, a centralized processing device that centrally processes the multi-modal information) based on the multi-modal information.

For example, the type of multi-modal communication or service is real-time translation. The process of the real-time translation may include capturing an image of the mouth of the user and collecting voice information of the user, and outputting a translation result based on the image of the mouth and the voice information. The above process can be performed by the terminal and the result is sent to other devices. Alternatively, the above process can be performed by the terminal in cooperation with other devices, for example, the terminal sends the image of the mouth and the voice information to other devices, and the other devices output the translation result based on the image of the mouth and the voice information.

For example, the type of multi-modal communication or service is directional control. The process of directional control may include capturing an image of body motion of the user and collecting voice information of the user, determining the object to be controlled and actions that the object needs to perform based on the image of the body motion and the voice information. The above process can be performed by the terminal, and the result is sent to other devices. Alternatively, the process can be performed by the terminal in cooperation with other devices, for example, the terminal sends the image of the body motion of the user and the voice information to other devices, and the other devices determine the object to be controlled and actions that the object needs to perform based on the image of the body motion and the voice information.

In general, the communication between the terminal and other devices based on the multi-modal information needs to be implemented based on a network device. The network device can support the multi-modal communication or service initiated by the terminal. Different terminals support different types of multi-modal communications or services, and different core networks support different multi-modal communications or services.

According to embodiments of the disclosure, the terminal may send the type of the multi-modal communication or service supported by itself as the capability information to the network device, so that the network device can learn the type of the multi-modal communication or service supported by the terminal, select an appropriate core network or use an appropriate core network function to support this type of multi-modal communication or service and provide services for the terminal. In this way, it can ensure that when the terminal initiates this type of multi-modal communication or service, the communication is performed smoothly.

In an example, the network device may be a base station, the delay allowed by the first type of multi-modal communication or service is low, the second type of multi-modal communication or service requires high reliability, the first core network can support the multi-modal communication or service with low communication delay, and the second core network can support the multi-modal communication or service with high communication reliability.

If the terminal A supports the first type of multi-modal communication or service, the terminal A may send the capability information to the base station, where the capability information is configured to indicate that the terminal A supports the first type of multi-modal communication or service. After receiving the capability information sent by terminal A, the base station can determine that the delay allowed by the first type of multi-modal communication or service is low, and the first core network can be selected to provide services for the terminal. Since the first core network can support the multi-modal communication or service with low communication delay, after the terminal A initiates the first type of multi-modal communication or service, under the services provided by the first core network, the low communicate delay can be ensured and the requirements of the first type of multi-modal communication or service can be satisfied.

If the terminal B supports the second type of multi-modal communication or service, the terminal B may send capability information to the base station, where the capability information is configured to indicate that the terminal B supports the second type of multi-modal communication or service. After receiving the capability information sent by the terminal B, the base station can determine that the second type of multi-modal communication or service requires high reliability, and the second core network can be selected to provide services for the terminal. Since the second core network can support the multi-modal communication or service with high communication reliability, after the terminal B initiates the second type of multi-modal communication or service, under the services provided by the second core network, the high communicate reliability can be ensured and the requirements of the second type of multi-modal communication or service can be satisfied.

FIG. 2 is a schematic flowchart illustrating another method for capability reporting according to embodiments of the disclosure. As illustrated in FIG. 2, sending the capability information about the type of multi-modal communication or service supported by the terminal to the network device includes the following.

In block S1011, the capability information is sent to the network device while accessing the network device.

In an embodiment, the terminal may send the capability information to the network device upon accessing the network device. When the terminal initiates the multi-modal communication or service after accessing the network device, the network device has learned about the type of the multi-modal communication or service supported by the terminal, such that an appropriate core network can be selected or an appropriate core network function can be used to support this type of multi-modal communication or service, and services are provided for the terminal to ensure that when the terminal initiates this type of multi-modal communication or service, the communication can be carried out smoothly.

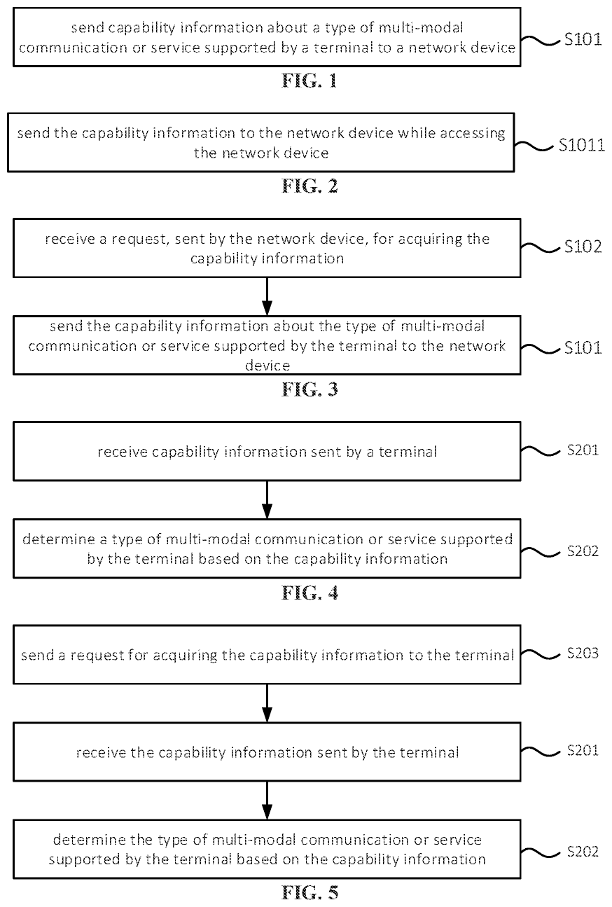

FIG. 3 is a schematic flowchart illustrating yet another method for capability reporting according to embodiments of the disclosure. As illustrated in FIG. 3, before sending the capability information about the type of multi-modal communication or service supported by the terminal to the network device, the method further includes the following.

In block S102, a request for acquiring the capability information sent by the network device is received.

In an embodiment, the terminal may send the capability information to the network device after receiving, from the network device, the request for acquiring the capability information, to ensure that the capability information is sent to the network device when the network device needs the capability information, and the capability information does not need to be sent to the network device when the network device does not need the capability information (i.e., when the request for acquiring the capability information is not received from the network device). In this way, the resources of the terminal can be saved.

It is noteworthy that the situation in which the terminal sends the capability information to the network device can be flexibly configured as needed, which is not limited to the situations described in the embodiments illustrated in FIG. 2 and FIG. 3. For example, the terminal may periodically send the capability information to the network device.

In some examples, the network device is selected from a group including at least one of the following:

a base station, or a core network.

In an embodiment, the network device may be a base station or a core network. The terminal may send the capability information about the type of the multi-modal communication or service supported by the terminal to the base station as required, or may send the capability information about the type of the multi-modal communication or service supported by the terminal to the core network.

In the case where the network device is a base station, for the base station, after receiving the capability information, the core network that supports this type of multi-modal communication or service can be determined from core networks accessed by the base station, and the base station can communicate with the core network to provide services for the terminal.

In the case where the network device is a core network, for the core network, after receiving the capability information, the core network can determine a function of the core network (or called the core network function or a network element) that supports this type of multi-modal communication or service from its own functions, and provide services for the terminal through the determined core network function.

In some examples, the network device is a base station, and the capability information is included in at least one of:

user equipment capability information signaling, radio resource control connection setup completion signaling, and radio resource control setup completion signaling.

In an embodiment, the terminal may send the capability information to the base station by carrying the capability information through the user equipment capability information (UECapabilityInformation) signaling, or through the radio resource control connection setup completion (RRCCONNECTIONSETUPCOMPLETE, which is a signaling in the 4G technology) signaling, or through the radio resource control setup completion signaling (RRCSETUPCOMPLETE, which is a signaling in the 5G technology).

In some examples, the network device is a core network, and the capability information is included in at least one of:

attach request signaling, or registration request signaling.

In an embodiment, the terminal may send the capability information to the core network by carrying the capability information through the attach request (Attach Request) signaling, or through the registration request (Registration Request) signaling. These two signaling belongs to the non-access layer signaling. For these two kinds of signaling, the base station can transparently transmit (pass through) them to the core network.

FIG. 4 is a schematic flowchart illustrating a method for capability determining according to embodiments of the disclosure. The method shown in this embodiment can be performed by a network device. The network device can be a base station or a core network. The base station is selected from a group including but not limited to a 4G base station, a 5G base station, or a 6G base station. The core network is selected from a group including but not limited to a 4G core network, a 5G core network, or a 6G core network. The network device can communicate with a terminal which is used as user equipment. The terminal is selected from a group including but not limited to electronic devices such as a mobile phone, a tablet computer, a wearable device, a sensor, and an Internet of Things device. The terminal is the one for performing the above-described method for capability reporting.

As illustrated in FIG. 4, the method for capability determining may include the following.

In block S201, the capability information sent by the terminal is received.

In block S202, the type of multi-modal communication or service supported by the terminal is determined according to the capability information.

According to the embodiments of the disclosure, the terminal can send the type of the multi-modal communication or service supported by itself as the capability information to the network device, and the network device can determine the type of the multi-modal communication or service supported by the terminal according to the capability information, select an appropriate core network or use an appropriate core network function to support this type of multi-modal communication or service, and provide services for the terminal to ensure that when the terminal initiates this type of multi-modal communication or service, the communication can be performed smoothly.

FIG. 5 is a schematic flowchart illustrating another method for capability determining according to embodiments of the disclosure. As illustrated in FIG. 5, the network device is a base station, and before receiving the capability information sent by the terminal, the method further includes the following.

In block S203, a request for acquiring the capability information is sent to the terminal.

The request is included in user equipment capability enquiry (UECapabilityEnquiry signaling.

In an embodiment, when the network device is a base station, the base station may send the request for acquiring the capability information to the terminal, such that the terminal sends the capability information to the base station after receiving the request for acquiring the capability information.

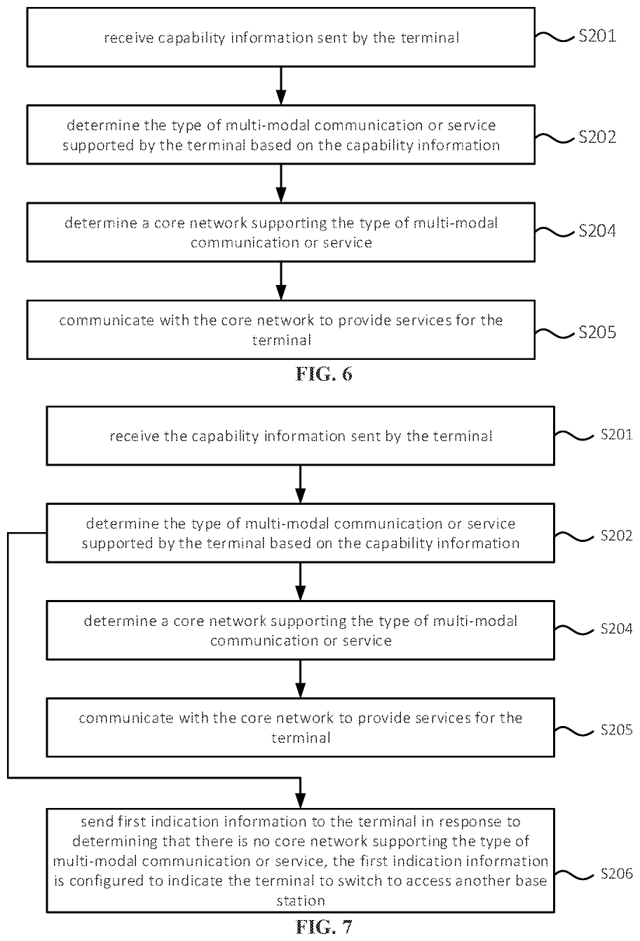

FIG. 6 is a schematic flowchart illustrating yet another method for capability determining according to embodiments of the disclosure. As illustrated in FIG. 6, the network device is a base station, and the method further includes the following.

In block S204, a core network supporting the type of multi-modal communication or service is determined.

In block S205, services are provided for the terminal by communicating with the core network.

In an embodiment, in the case where the network device is a base station, for the base station, after receiving the capability information, the base station may determine the core network that supports the type of multi-modal communication and service from the core networks accessed by the base station and communicate with the determined core network to provide services for the terminal.

FIG. 7 is a schematic flowchart illustrating yet another method for capability determining according to embodiments of the disclosure. As illustrated in FIG. 7, the method further includes the following.

In block S206, first indication information is sent to the terminal in response to determining that there is no core network supporting the type of multi-modal communication or service. The first indication information is configured to indicate the terminal to switch to access another base station.

In an embodiment, the number of core networks that the base station accesses is limited, and among the core networks that the base station accesses, there may be some core networks that support the type of multi-modal communication or service and there may be no core network that supports the type of multi-modal communication or service. If there is no core network that supports the type of multi-modal communication or service among the core networks that the base station accesses and there may be a core network that supports the type of multi-modal communication or service among the core networks that another base station accesses, the base station can send the first indication information to the terminal, and indicate the terminal to access to another base station through the first indication information, such that another base station can determine the core network supporting the type of multi-modal communication or service and communicate with the determined core network to provide services for the terminal.

FIG. 8 is a schematic flowchart illustrating yet another method for capability determining according to embodiments of the disclosure. As illustrated in FIG. 8, the network device is a core network, and the method further includes the following.

In block S207, set-vices are provided for the terminal through a function of the core network supporting the type of multi-modal communication or service.

In an embodiment, in the case where the network device is a core network, for the core network, after receiving the capability information, the core network can determine, from its own functions (or referred to as network elements), a function of the core network (or called core network function) supporting the type of multi-modal communication or service, and provide services for the terminal through the determined core network function.

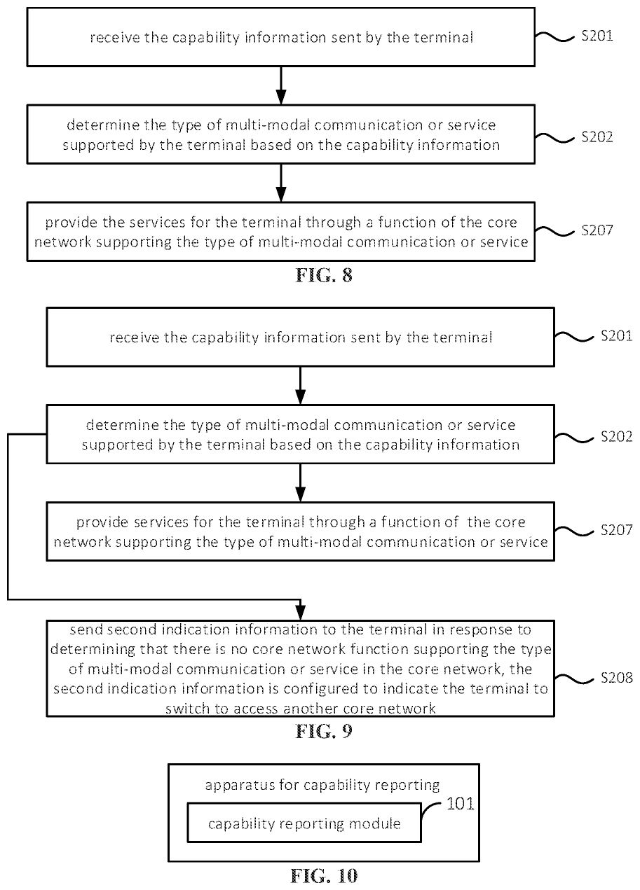

FIG. 9 is a schematic flowchart illustrating yet another method for capability determining according to embodiments of the disclosure. As illustrated in FIG. 9, the method further includes the following.

in block S208, second indication information is sent to the terminal in response to determining that there is no core network function supporting the type of multi-modal communication or service in the core network. The second indication information is configured to indicate the terminal to switch to access another core network.

In an embodiment, for the core network, the number of core network functions is limited. If there is no core network function supporting the type of multi-modal communication or service among the core network functions of the core network, but there is a core network function supporting the type of multi-modal communication or service in another core network, the core network can send the second indication information to the terminal, and indicate the terminal to switch to access another core network through the second indication information, such that the terminal accesses another core network and another core network can provide services for the terminal through the core network function when another core network has the core network function for supporting the type of multi-modal communication or service.

Corresponding to the foregoing embodiments of the method for capability reporting and the method for determining the capabilities, the disclosure further provides embodiments of apparatuses for capability reporting and apparatuses for capability determining.

FIG. 10 is a schematic block diagram illustrating an apparatus for capability reporting according to embodiments of the disclosure. The apparatus shown in this embodiment may be applied to a terminal The terminal is selected from a group including but not limited to electronic devices such as a mobile phone, a tablet computer, a wearable device, a sensor, and an Internet of Things device. The terminal can be user equipment (UE) to communicate with the network device such as a base station and a core network. The base station is selected from a group including but not limited to a 4G base station, a 5G base station, or a 6G base station. The core network is selected from a group including but not limited to a 4G core network, a 5G core network, or a 6G core network.

As illustrated in FIG. 10, the apparatus for capability reporting may include a capability reporting module 101.

The capability reporting module 101 is configured to send capability information about a type of multi-modal communication or service supported by the terminal to a network device.

In some examples, the capability reporting module is configured to send the capability information to the network device while accessing the network device.

FIG. 11 is a schematic block diagram illustrating another apparatus for capability reporting according to embodiments of the disclosure. As illustrated in FIG. 11, the apparatus further includes a request receiving module 102.

The request receiving module 102 is configured to receive a request, sent by the network device, for acquiring the capability information.

In some examples, the network device is selected from a group including at least one of:

a base station, or a core network.

In some examples, the network device is a base station, and the capability information is included in at least one of:

user equipment capability information signaling, radio resource control connection setup completion signaling, or radio resource control setup completion signaling.

In some examples, the network device is a core network, and the capability information is included in at least one of:

attach request signaling, or registration request signaling.

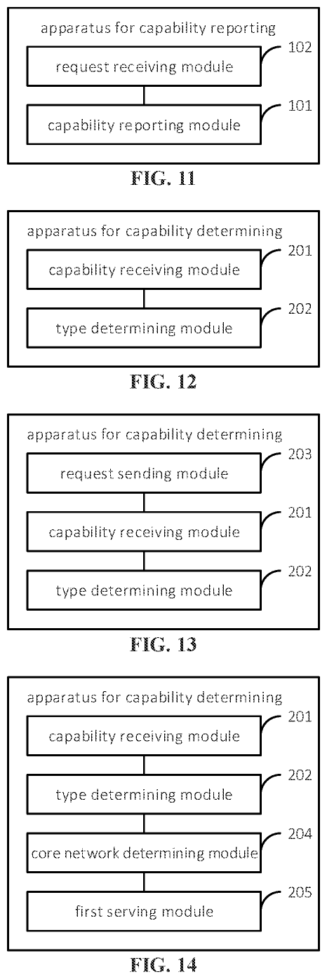

FIG. 12 is a schematic block diagram illustrating an apparatus for capability determining according to embodiments of the disclosure. The apparatus shown in this embodiment can be applied to a network device. The network device can be a base station or a core network. The base station is selected from a group including but not limited to a 4G base station, a 5G base station, or a 6G base station. The core network is selected from a group including but not limited to a 4G core network, a 5G core network, or a 6G core network. The network device can communicate with a terminal which is used as user equipment The terminal is selected from a group including but not limited to electronic devices such as a mobile phone, a tablet computer, a wearable device, a sensor, and an Internet of Things device. The terminal is the one fir performing the above-described method for capability reporting.

As illustrated in FIG. 12, the apparatus for capability determining may include a capability receiving module 201 and a type determining module 202.

The capability receiving module 201 is configured to receive capability information sent by the terminal.

The type determination module 202 is configured to determine the type of multi-modal communication or service supported by the terminal according to the capability information.

FIG. 13 is a schematic block diagram illustrating another apparatus for capability determining according to embodiments of the disclosure. As illustrated in FIG. 13, the network device is a base station, and the apparatus further includes a request sending module 203.

The request sending module 203 is configured to send a request for acquiring the capability information to the terminal.

The request is included in user equipment capability enquiry signaling.

FIG. 14 is a schematic block diagram illustrating still another apparatus capability determining according to embodiments of the disclosure. As illustrated in FIG. 14, the network device is a base station, and the apparatus further includes a core network determining module 204 and a first serving module 205.

The core network determining module 204 is configured to determine a core network supporting the type of multi-modal communication or service.

The first service module 205 is configured to communicate with the core network to provide services for the terminal.

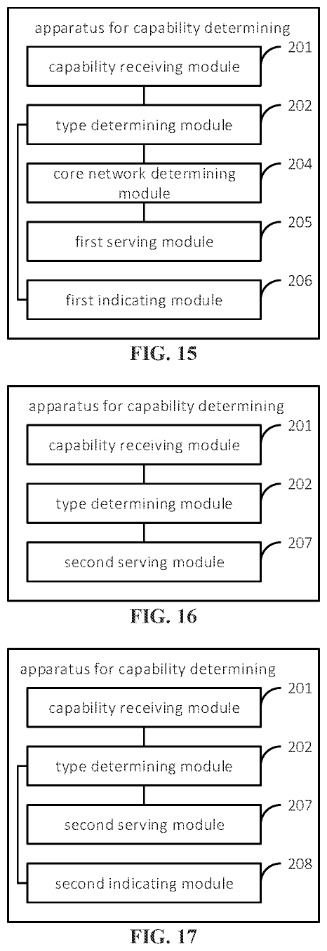

FIG. 15 is a schematic block diagram illustrating vet another apparatus for capability, determining according to embodiments of the disclosure. As illustrated in FIG. 15, the apparatus further includes a first indicating module 206.

The first indicating module 206 is configured to send first indication information to the terminal in response to determining that there is no core network supporting the type of multi-modal communication or service, where the first indication information is configured to indicate terminal to switch to access another base station.

FIG. 16 is a schematic block diagram illustrating yet another apparatus for capability determining according to embodiments of the disclosure. As illustrated in FIG. 16, the network device is a core network, and the apparatus further includes a second serving module 207.

The second serving module 207 is configured to provide services for the terminal through a function of the core network supporting the type of multi-modal communication or service.

FIG. 17 is a schematic block diagram illustrating yet another apparatus for capability determining according to embodiments of the disclosure. As illustrated in FIG. 17, the apparatus further includes a second indicating module 208.

The second indicating module 208 is configured to send second indication information to the terminal in response to determining that there is no core network function supporting the type of multi-modal communication or service in the core network, where the second indication information is configured to indicate the terminal to switch to access another core network.

Regarding the apparatuses in the foregoing embodiments, the specific manners in which each module performs operations have been described in detail in the embodiments of the related methods, and will not be described in detail here.

For the apparatus embodiments, since they basically correspond to the method embodiments, reference may be made to the partial descriptions of the method embodiments for related parts. The apparatus embodiments described above are only illustrative, the modules described as separate components may or may not be physically separated, and the components displayed as modules may or may not be physical modules, that is, they may be located in one place distributed over multiple network modules. Some or all of the modules may be selected according to actual needs to achieve the purpose of the solution in these embodiments. Those of ordinary skill in the art can understand and implement the solution without creative effort.

Embodiments of the disclosure also provide an electronic device including:

a processor; and

a memory for storing instructions executable by the processor.

The processor is configured to perform the method for capability reporting described in any of the foregoing embodiments and/or the method for capability determining described in any of the foregoing embodiments.

Embodiments of the disclosure also provide a computer-readable storage medium, on which a computer program is stored. When the program is executed by a processor, the method for capability reporting described in any of the foregoing embodiments and/or the method for capability determining described in any of the foregoing embodiments is performed.

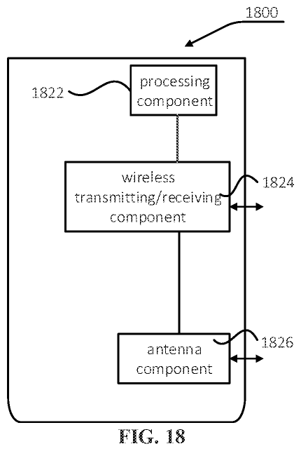

As illustrated in FIG. 18, FIG. 18 is a schematic block diagram illustrating a device 1800 for capability determining according to embodiments of the disclosure. The apparatus 1800 may be provided as a base station or a core network. As illustrated in FIG. 18, the apparatus 1800 includes a processing component 1822, a wireless transmitting/receiving component 1824, an antenna component 1826, and a signal processing portion specific to a wireless interface. The processing component 1822 may further include one or more processors. One of the processors in the processing component 1822 may be configured to perform the method for capability determining described in any of the above embodiments.

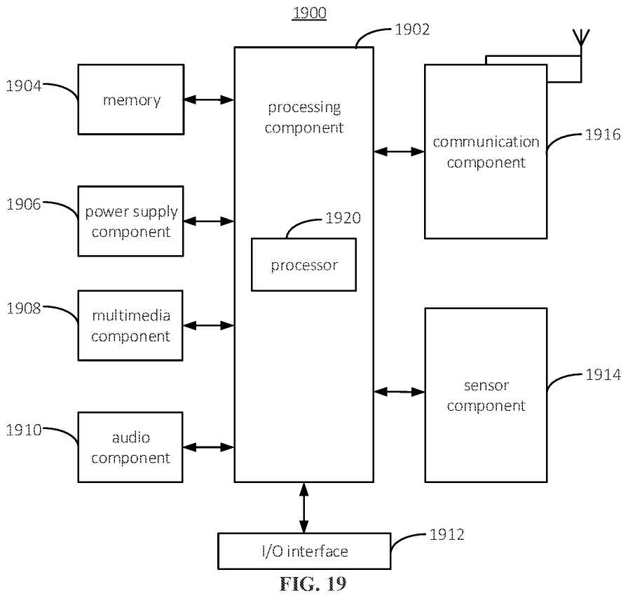

FIG. 19 is a schematic block diagram illustrating a device 1900 for capability reporting according to embodiments of the disclosure. For example, the device 1900 may be a mobile phone, a computer, a digital broadcast terminal, a messaging device, a game console, a tablet device, a medical device, a fitness device, a personal digital assistant, and the like.

As illustrated in FIG. 19, the device 1900 may include one or more of the following components: a processing component 1902, a memory 1904, a power supply component 1906, a multimedia component 1908, an audio component 1910, an input/output (I/O) interface 1912, a sensor component 1914, and a communication component 1916.

The processing component 1902 generally controls the overall operation of the device 1900, such as operations associated with display, phone calls, data communications, camera operations, and recording operations. The processing component 1902 can include one or more processors 1920 to execute instructions to perform all or some of the steps of the methods for capability reporting described above. Additionally, processing component 1902 may include one or more modules that facilitate interaction between processing component 1902 and other components. For example, processing component 1902 may include a multimedia module to facilitate interaction between multimedia component 1908 and processing component 1902.

The memory 1904 is configured to store various types of data to support operations of the device 1900. Examples of such data include instructions for any application or method operating on the device 1900, contact data, phonebook data, messages, pictures, videos, and the like. The memory 1904 may be implemented by any type of volatile or non-volatile storage device or combination thereof, such as static random access memory (SRAM), electrically erasable programmable read only memory (EEPROM), erasable Programmable Read Only Memory (EPROM), Programmable Read Only Memory (PROM), Read Only Memory (ROM), Magnetic Memory, Flash Memory, Magnetic Disk or Optical Disk.

The power supply component 1906 provides power to various components of the device 1900. The power supply component 1906 may include a power management system, one or more power supplies, and other components associated with generating, managing, and distributing power to the device 1900.

The multimedia component 1908 includes a screen that provides an output interface between the device 1900 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel, The touch sensors can sense not only the boundaries of a touch or swipe action, but also the duration and pressure associated with the touch or swipe action. In some embodiments, the multimedia component 1908 includes a front-facing camera and/or a rear-facing camera. When the device 1900 is in an operation mode, such as a shooting mode or a video mode, the front-facing camera and/or the rear-facing camera may receive external multimedia data. Each of the front-facing and rear-facing cameras can be a fixed optical lens system or have focal length and optical zoom capability.

The audio component 1910 is configured to output and/or input audio signals. For example, audio component 1910 includes a microphone (MIC) that is configured to receive external audio signals when the device 1900 is in operating modes, such as call mode, recording mode, and voice recognition mode. The received audio signal may be further stored in the memory 1904 or transmitted via the communication component 1916. In some embodiments, the audio component 1910 also includes a speaker for outputting audio signals.

The I/O interface 1912 provides an interface between the processing component 1902 and a peripheral interface module, which may be a keyboard, a click wheel, a button, and the like. These buttons may include, but are not limited to: home button, volume buttons, start button, and lock button.

The sensor component 1914 includes one or more sensors for providing status assessment of various aspects of the device 1900. For example, the sensor component 1914 can detect the on/off state of the device 1900, the relative positioning of components, such as the display and keypad of the device 1900, the sensor component 1914 can also detect a change in the position of the device 1900 or a component of the device 1900, the presence or absence of contact with the device 1900, the orientation or acceleration/deceleration of the device 1900 and the temperature change of the device 1900. The sensor component 1914 may include a proximity sensor configured to detect the presence of nearby objects in the absence of any physical contact. The sensor component 1914 may also include a light sensor, such as a CMOS or CCD image sensor, for use in imaging applications. In some embodiments, the sensor component 1914 may also include an acceleration sensor, a gyroscope sensor, a magnetic sensor, a pressure sensor, or a temperature sensor.

The communication component 1916 is configured to facilitate wired or wireless communication between the device 1900 and other devices. The device 1900 may access a wireless network based on a communication standard, such as Wi-Fi, 2G, 3G, 4G LTE, 5G NR or a combination thereof. In one embodiment, the communication component 1916 receives broadcast signals or broadcast related information from an external broadcast management system via a broadcast channel, In an embodiment, the communication component 316 also includes a near field. communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies,

In an embodiment, the device 1900 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component implementation for performing the above method.

In some embodiments, there is further provided a non-transitory computer-readable storage medium including instructions, such as the memory 1904 including instruction. The instruction are executed by a processor 1920 of the device 1900 to execute the above-mentioned method for capability reporting. For example, the non-transitory computer-readable storage medium may be ROM, random access memory (RAM), CD-ROM, tape, floppy disk, optical data storage device or the like.

According to the embodiments of the disclosure, the terminal may send one or more types of the multi-modal communication or service supported by itself as the capability information to the network device, so that the network device can learn the one or more types of the multi-modal communication or service supported by the terminal, and one or more appropriate core networks can be selected or one or more appropriate core network functions can be used to support the one or more types of the multi-modal communication or service to provide services for the terminal. In this way, it can ensure that the communication can be smoothly performed when the terminal initiates these one or more types of multi-modal communications or services.

Other embodiments of the disclosure will readily occur to those skilled in the art upon consideration of the specification and practice of the disclosure disclosed herein. This disclosure is intended to cover any variations, uses, or adaptations of the disclosure that follow the general principles of the disclosure and include common knowledge or techniques in the technical field not disclosed by the disclosure. The specification and examples are to be regarded as illustrative only, with the true scope and spirit of the disclosure being indicated by the following claims.

It is understandable that the disclosure is not limited to the precise structures described above and illustrated in the accompanying drawings, and that various modifications and changes may be made without departing from the scope thereof. The scope of the disclosure is limited only by the appended claims.

It is noteworthy that, in this disclosure, relational terms such as “first” and “second” are used only to distinguish one entity or operation from another entity or operation, and do not necessarily require or imply any actual relationship or sequence between these entities or operations. The terms “comprise”, “include” or any other variation thereof are intended to encompass non-exclusive inclusion such that a process, method, article or device comprising a list of elements includes not only those elements, but also other not expressly listed elements, or also include elements inherent to such a process, method, article or apparatus. Without further limitation, an element qualified by the phrase “comprising a . . . ” does not preclude the presence of additional identical elements in a process, method, article or apparatus that includes the element.

The methods and apparatuses according to embodiments of the disclosure have been described in detail above, and specific examples are used to illustrate the principles and implementations of the disclosure. At the same time, for those of ordinary skill in the art, according to the idea of the disclosure, there will be changes in the specific implementation and application scope. In summary, the contents of this specification should not be construed as limiting the disclosure.

1. A method for capability reporting, performed by a terminal, the method comprising:
sending capability information about a type of multi-modal communication or service supported by the terminal to a network device.

2. The method of claim 1, wherein sending the capability information about the type of multi-modal communication or service supported by the terminal to the network device comprises:
sending the capability information to the network device while accessing the network device.

3. The method of claim 1, further comprising:
receiving a request, sent by the network device, for acquiring the capability information.

4. The method of claim 1, wherein the network device is a base station, and the capability information is contained in at least one of:
a user equipment capability information signaling, a radio resource control layer connection setup completion signaling, or a radio resource control layer setup completion signaling.

5. The method of claim 1, wherein the network device is a core network, and the capability information is contained in at least one of:
an attach request signaling, or a registration request signaling.

6. A method for capability determining, performed by a network device, the method comprising:
receiving capability information sent by a terminal; and
determining a type of multi-modal communication or service supported by the terminal based on the capability information.

7. The method of claim 6, wherein the network device is a base station, and before receiving the capability information sent by the terminal, the method further comprises:
sending a request for acquiring the capability information to the terminal;
wherein the request is contained in a user equipment capability enquiry signaling.

8. The method of claim 6, wherein the network device is a base station, and the method further comprises:
determining a core network supporting the type of multi-modal communication or service; and
communicating with the core network to provide services to the terminal.

9. The method of claim 8, further comprising:
sending first indication information to the terminal in response to determining that there is no core network supporting the type of multi-modal communication or service, wherein the first indication information is configured to indicate the terminal to access another base station.

10. The method of claim 6, wherein the network device is a core network, and the method further comprises:
providing, by a function of the core network supporting the type of multi-modal communication or service, services to the terminal.

11. The method of claim 10, further comprising:
sending second indication information to the terminal in response to determining that there is no core network function supporting the type of multi-modal communication or service in the core network, wherein the second indication information is configured to indicate the terminal to access another core network.

12. (canceled)

13. (canceled)

14. A terminal, comprising:
a processor; and
a memory configured to store instructions executable by the processor;
wherein the processor is configured to:
send capability information about a type of multi-modal communication or service supported by the terminal to a network device.

15. A non-transitory computer-readable storage medium having stored thereon a computer program that, when executed by a processor, causes the processor to perform the method of claim 1.

16. The terminal of claim 14, wherein the processor is further configured to:
send the capability information to the network device while accessing the network device.

17. The terminal of claim 14, wherein the processor is further configured to:
receive a request, sent by the network device, for acquiring the capability information.

18. The terminal of claim 14, wherein the network device is a base station, and the capability information is contained in at least one of:
a user equipment capability information signaling, a radio resource control layer connection setup completion signaling, or a radio resource control layer setup completion signaling.

19. The terminal of claim 14, wherein the network device is a core network, and the capability information is contained in at least one of:
an attach request signaling, or a registration request signaling.

20. A network device, comprising:
a processor; and
a memory configured to store instructions executable by the processor;
wherein the processor is configured to perform the method of claim 6.

21. A non-transitory computer-readable storage medium having stored thereon a computer program that, when executed by a processor, causes the processor to perform the method of claim 6.
